(19) United States
(12) Patent Application Publication
(10) Pub. No.: US 2021/0154533 A1
(43) Pub. Date: May 27, 2021

(54) GOLF BALL

(71) Applicant: Bridgestone Sports Co., Ltd., Tokyo (JP)

(72) Inventors: Masahiro YAMABE, Chichibushi (JP); Katsunobu Mochizuki, Chichibushi (JP)

(73) Assignee: Bridgestone Sports Co., Ltd., Tokyo (JP)

(21) Appl. No.: 17/079,953

(22) Filed: Oct. 26, 2020

(30) Foreign Application Priority Data
Nov. 26, 2019 (JP) 2019-212795

(51) Int. Cl. A63B 37/00; C08L 75/08; C08L 67/00; B32B 1/00; B32B 25/08; B32B 27/40; B32B 27/36

(52) U.S. Cl. CPC A63B 37/0039; A63B 37/0043; A63B 37/0094; A63B 37/0075; B32B 27/36; C08L 67/00; B32B 1/00; B32B 25/08; B32B 27/40; C08L 75/08

(57) ABSTRACT

In a golf ball having a rubber core of at least one layer and an inner cover layer and outer cover layer which encase the core, the inner cover layer is formed of a resin composition that includes (A) a polyurethane or polyurea and (B) a thermoplastic polyester elastomer, which resin composition has a Shore D hardness of 52 or less and a rebound resilience of at least 50%, and the outer cover layer is formed of a resin composition which includes a polyurethane or polyurea of the same type as component (A) or of a different type. This ball has an improved rebound, an optimal spin rate on approach shots and thus a good controllability, and an excellent durability.

### CROSS-REFERENCE TO RELATED APPLICATION

This non-provisional application claims priority under 35 U.S.C. § 119(a) on Patent Application No. 2019-212795 filed in Japan on Nov. 26, 2019, the entire contents of which are hereby incorporated by reference.

### TECHNICAL FIELD

The present invention relates to a golf ball of three or more pieces which has a core of at least one layer and a two-layer cover consisting of an inner cover layer and an outer cover layer.

### BACKGROUND ART

Numerous three-piece or four-piece golf balls having a ball construction that includes a cover of two or more layers provided over a rubber core are currently on the market. In such multi-piece golf balls, for reasons having to do with the rebound, spin performance and other properties of the ball, the outer cover layer (also called the “outermost layer”) and the inner cover layer (also called the “intermediate layer”) are often formed of differing resin materials.

Also, particularly in balls for professional golfers and skilled amateur golfers, urethane resin materials are commonly used in place of ionomer materials as the cover material making up the outermost layer. The combination of materials in the two-layer cover of the golf ball is often one in which the inner cover layer is formed of an ionomer resin and the outer cover layer is formed of a polyurethane resin. However, such golf balls have a poor durability to cracking, and so various modifications are carried out to increase adhesion between the layers.

To resolve the problem of decreased adhesion owing to the difference in materials used in the two-layer cover, golf balls in which the intermediate layer is made of the same type of urethane material as the outermost layer have been described. For example, JP-A 2003-325703 and JP-A 2003-325704 disclose golf balls which, by having a core, an inner cover layer (intermediate layer) encasing the core and an outer cover layer encasing the intermediate layer, and by forming the outer cover layer of a polyurethane-type elastomer and forming the intermediate layer of a resin material containing at least 50 wt % of a polyurethane-type elastomer, have a good distance and feel at impact on full shots with various types of clubs and also have an excellent durability and scuff resistance.

However, because a urethane resin material is used in the intermediate layer, these golf balls leave something to be desired in terms of rebound and durability, and so there remains room for improvement.

### SUMMARY OF THE INVENTION

It is therefore an object of the present invention to provide a golf ball that exhibits even further improvement in both rebound and durability.

As a result of extensive investigations, we have found that, in a golf ball having an outer cover layer and an inner cover layer which are formed of polyurethane materials, by blending a thermoplastic polyester elastomer with a urethane resin material to give the inner cover layer-forming resin material and also setting the Shore D hardness and rebound resilience of the inner cover layer within specific ranges, a better durability and a better rebound can be obtained than when a urethane resin is used alone in the inner and outer cover layers. In addition, we have discovered that this golf ball has an optimized spin rate on approach shots and that the feel of the ball on impact can be improved.

Accordingly, the invention provides a golf ball have a rubber core of at least one layer and an inner cover layer and outer cover layer which encase the core, wherein the inner cover layer is formed of a resin composition that includes (A) a polyurethane or polyurea and (B) a thermoplastic polyester elastomer, which resin composition has a Shore D hardness of 52 or less and a rebound resilience of at least 50%; and the outer cover layer is formed of a resin composition that includes a polyurethane or polyurea of the same type as component (A) or of a different type.

In a preferred embodiment of the golf ball of the invention, the resin composition of the inner cover layer has a Shore D hardness of 50 or less and a rebound resilience of at least 52%.

In another preferred embodiment of the inventive golf ball, the proportion of component (B) in the inner cover layer-forming resin composition is 80 wt % or less.

In yet another preferred embodiment, the component (A) resin material in the inner cover layer-forming resin composition has a Shore D hardness of at least 55 and a rebound resilience of 48% or less.

In still another preferred embodiment, the component (B) resin material in the inner cover layer-forming resin composition has a Shore D hardness of 55 or less and a rebound resilience of at least 48%.

In a further preferred embodiment, the inner cover layer-forming resin composition has a blending ratio between components (A) and (B) which, expressed as the weight ratio (A)/(B), is from 20/80 to 80/20.

### Advantageous Effects of the Invention

The golf ball of the invention has an improved rebound, an optimal spin rate on approach shots and thus a good controllability, and moreover an excellent durability.

### BRIEF DESCRIPTION OF THE DIAGRAMS

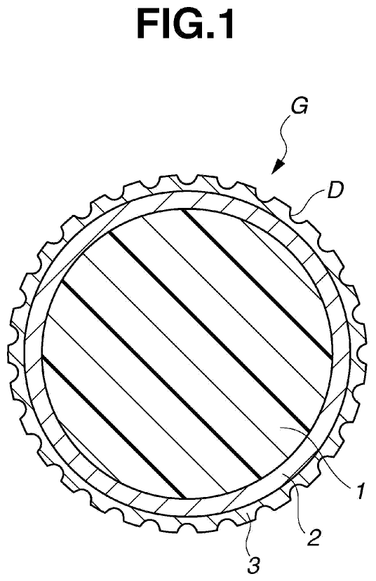

FIG. 1 is a schematic cross-sectional view of the golf ball according to one embodiment of the invention.

### DESCRIPTION OF THE PREFERRED EMBODIMENTS

The objects, features and advantages of the invention will become more apparent from the following detailed description taken in conjunction with the appended diagrams.

The golf ball of the invention has multiple cover layers—namely, an inner cover layer and an outer cover layer—formed over a core that is composed of at least one layer. For example, referring to FIG. 1, the golf ball may be a multi-piece solid golf ball G having a core 1, an inner cover layer 2 encasing the core 1, and an outer cover layer 3 encasing the inner cover layer 2. The outer cover layer 3 is positioned as the outermost layer, apart from a coating layer, in the layered structure of the golf ball. Numerous dimples D are typically formed on the surface of the outer cover layer (outermost layer) 3 so as to improve the aerodynamic properties of the ball. Although not shown in the diagram, a coating layer is typically formed on the surface of the outer cover layer 3.

The core may be formed using a known rubber material as the base material. A known base rubber such as a natural rubber or a synthetic rubber may be used as the base rubber. More specifically, it is recommended that polybutadiene, especially cis-1,4-polybutadiene having a cis structure content of at least 40%, be chiefly used. If desired, natural rubber, polyisoprene rubber, styrene-butadiene rubber or the like may be used together with the foregoing polybutadiene in the base rubber.

The polybutadiene may be synthesized with a metal catalyst, such as a neodymium or other rare-earth catalyst, a cobalt catalyst or a nickel catalyst.

Co-crosslinking agents such as unsaturated carboxylic acids and metal salts thereof, inorganic fillers such as zinc oxide, barium sulfate and calcium carbonate, and organic peroxides such as dicumyl peroxide and 1,1-bis(t-butylperoxy)cyclohexane may be included in the base rubber. If necessary, commercial antioxidants and the like may be suitably added.

The core may be produced by vulcanizing/curing the rubber composition containing the above ingredients. For example, production may be carried out by kneading the composition using a mixer such as a Banbury mixer or a roll mill, compression molding or injection molding the kneaded composition using a core mold, and curing the molded body by suitably heating it at a temperature sufficient for the organic peroxide and the co-crosslinking agent to act, i.e., from about 100° C. to about 200° C., and preferably from 140 to 180° C., for a period of 10 to 40 minutes.

In this invention, the inner cover layer-forming resin material is formed of a resin composition containing components (A) and (B) below:

(A) a polyurethane or polyurea

(B) a thermoplastic polyester elastomer.

### (A) Polyurethane or Polyurea

Details on the polyurethane (A-1) or polyurea (A-2) serving as component (A) are given below.

### (A-1) Polyurethane

The polyurethane has a structure which includes soft segments composed of a polymeric polyol (polymeric glycol) that is a long-chain polyol, and hard segments composed of a chain extender and a polyisocyanate. Here, the polymeric polyol serving as a starting material may be any that has hitherto been used in the art relating to polyurethane materials, and is not particularly limited. It is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include poly(ethylene glycol), poly(propylene glycol), poly(tetramethylene glycol) and poly(methyltetramethylene glycol). These polyols may be used singly, or two or more may be used in combination.

It is preferable to use a polyether polyol as the above polymeric polyol.

The long-chain polyol has a number-average molecular weight that is preferably in the range of 1,000 to 5,000. By using a long-chain polyol having a number-average molecular weight in this range, golf balls made with a polyurethane composition that have excellent properties, including a good rebound and good productivity, can be reliably obtained. The number-average molecular weight of the long-chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic diols having from 2 to 12 carbon atoms. Specific examples include 1,4-butylene glycol, 1,2-ethylene glycol, 1,3-butanediol, 1,6-hexanediol and 2,2-dimethyl-1,3-propanediol. Of these, the use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method of preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use a thermoplastic polyurethane material as the polyurethane, with an ether-based thermoplastic polyurethane material being especially preferred. A commercial product may be suitably used as the thermoplastic polyurethane material; illustrative examples include those available under the trade name PANDEX from DIC Covestro Polymer, Ltd., and those available under the trade name RESAMINE from Dainichiseika Color & Chemicals Mfg. Co., Ltd.

### (A-2) Polyurea

The polyurea is a resin composition composed primarily of urea linkages formed by reacting (i) an isocyanate with (ii) an amine-terminated compound. This resin composition is described in detail below.

### (i) Isocyanate

The isocyanate is not particularly limited. Any isocyanate used in the prior art relating to polyurethanes may be suitably used here. Use may be made of isocyanates similar to those mentioned above in connection with the polyurethane material.

### (ii) Amine-Terminated Compound

An amine-terminated compound is a compound having an amino group at the end of the molecular chain. In this invention, the long-chain polyamines and/or amine curing agents shown below may be used.

A long-chain polyamine is an amine compound which has on the molecule at least two amino groups capable of reacting with isocyanate groups, and which has a number-average molecular weight of from 1,000 to 5,000. In this invention, the number-average molecular weight is more preferably from 1,500 to 4,000, and even more preferably from 1,900 to 3,000. Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

An amine curing agent is an amine compound which has on the molecule at least two amino groups capable of reacting with isocyanate groups and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine), 1,3-cyclohexane bis(methylamine), diethylene glycol di(aminopropyl) ether, 2-methylpentamethylenediamine, diaminocyclohexane, diethylenetriamine, triethylenetetramine, tetraethylenepentamine, propylenediamine, 1,3-diaminopropane, dimethylaminopropylamine, diethylaminopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroaniline), 3,5-dimethylthio-2,4-toluenediamine, 3,5-dimethylthio-2,6-toluenediamine, 3,5-diethylthio-2,4-toluenediamine, 3,5-diethylthio-2,6-toluenediamine, 4,4′-bis(sec-butylamino)diphenylmethane and derivatives thereof, 1,4-bis(sec-butylamino)benzene, 1,2-bis(sec-butylamino)benzene, N,N′-dialkylaminodiphenylmethane, N,N,N′,N′-tetrakis(2-hydroxypropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to above components (i) and (ii), a polyol may also be included in the polyurea. The polyol is not particularly limited, but is preferably one that has hitherto been used in the art relating to polyurethanes. Specific examples include the long-chain polyols and/or polyol curing agents mentioned below.

The long-chain polyol may be any that has hitherto been used in the art relating to polyurethanes. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used singly or two or more may be used in combination.

The long-chain polyol has a number-average molecular weight of preferably from 1,000 to 5,000, and more preferably from 1,700 to 3,500. In this average molecular weight range, an even better resilience and productivity are obtained.

The polyol curing agent is preferably one that has hitherto been used in the art relating to polyurethanes, but is not subject to any particular limitation. In this invention, use may be made of a low-molecular-weight compound having on the molecule at least two active hydrogen atoms capable of reacting with isocyanate groups and having a molecular weight of less than 1,000. Of these, the use of aliphatic diols having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight of preferably less than 800, and more preferably less than 600.

A known method may be used to produce the polyurea. A prepolymer process, a one-shot process or some other known method may be suitably selected for this purpose.

Component (A) has a material hardness on the Shore D hardness scale which, from the standpoint of the golf ball spin properties and rebound that can be obtained by blending it with component (B), is preferably at least 55, more preferably at least 58, and even more preferably at least 61. From the standpoint of the moldability, the upper limit in the material hardness on the Shore D scale is preferably 68 or less, and more preferably 65 or less.

Component (A) has a rebound resilience, as measured in accordance with JIS-K 6255, which is preferably 48% or less, more preferably 46% or less, and even more preferably 44% or less.

### (B) Thermoplastic Polyester Elastomer

The thermoplastic polyester-type elastomer serving as component (B) is a resin composition made up of (b-1) a polyester block copolymer and (b-2) a rigid resin. In turn, component (b-1) is made up of (b-1-1) a high-melting crystalline polymer segment and (b-1-2) a low-melting polymer segment.

The high-melting crystalline polymer segment (b-1-1) making up the polyester block copolymer serving as component (b-1) is a polyester formed from one or more selected from the group consisting of aromatic dicarboxylic acids or ester-forming derivatives thereof and diols or ester-forming derivatives thereof.

Illustrative examples of aromatic dicarboxylic acids include terephthalic acid, isophthalic acid, phthalic acid, 2,6-naphthalenedicarboxylic acid, 2,7-naphthalenedicarboxylic acid, anthracenedicarboxylic acid, diphenyl-4,4′-dicarboxylic acid, diphenoxyethanedicarboxylic acid, 4,4′-diphenyletherdicarboxylic acid, 5-sulfoisophthalic acid and sodium 3-sulfoisophthalate. In this invention, an aromatic dicarboxylic acid is primarily used. However, where necessary, some of this aromatic dicarboxylic acid may be replaced with an alicyclic dicarboxylic acid such as 1,4-cyclohexanedicarboxylic acid, cyclopentanedicarboxylic acid or 4,4′-dicyclohexyldicarboxylic acid or with an aliphatic dicarboxylic acid such as adipic acid, succinic acid, oxalic acid, sebacic acid, dodecanedioic acid or a dimer acid. Exemplary ester-forming derivatives of dicarboxylic acids include lower alkyl esters, aryl esters, carboxylic acid esters and acid halides of the above dicarboxylic acids.

Next, a diol having a molecular weight of 400 or less may be suitably used as the diol. Specific examples include aliphatic diols such as 1,4-butanediol, ethylene glycol, trimethylene glycol, pentamethylene glycol, hexamethylene glycol, neopentyl glycol and decamethylene glycol; alicyclic diols such as 1,1-cyclohexanedimethanol, 1,4-dicyclohexanedimethanol and tricyclodecanedimethanol; and aromatic diols such as xylylene glycol, bis(p-hydroxy)diphenyl, bis(p-hydroxy)diphenylpropane, 2,2′-bis[4-(2-hydroxyethoxy)phenyl]propane, bis[4-(2-hydroxyethoxy)phenyl]sulfone, 1,1-bis[4-(2-hydroxyethoxy)phenyl]cyclohexane, 4,4′-dihydroxy-p-terphenyl and 4,4′-dihydroxy-p-quaterphenyl. Exemplary ester-forming derivatives of diols include acetylated forms and alkali metal salts of the above diols.

The above aromatic dicarboxylic acids, diols and derivatives thereof may be used singly or two or more may be used together.

In particular, the following may be suitably used as component (b-1-1): a high-melting crystalline polymer segment composed of polybutylene terephthalate units derived from terephthalic acid and/or dimethyl terephthalate together with 1,4-butanediol; a high-melting crystalline polymer segment composed of polybutylene terephthalate units derived from isophthalic acid and/or dimethyl isophthalate together with 1,4-butanediol; and a copolymer of both.

The low-melting polymer segment serving as component (b-1-2) is an aliphatic polyether and/or an aliphatic polyester.

Examples of the aliphatic polyether include poly(ethylene oxide) glycol, poly(propylene oxide) glycol, poly(tetramethylene oxide) glycol, poly(hexamethylene oxide) glycol, copolymers of ethylene oxide and propylene oxide, ethylene oxide addition polymers of poly(propylene oxide) glycol, and copolymer glycols of ethylene oxide and tetrahydrofuran. Examples of aliphatic polyesters include poly(ε-caprolactone), polyenantholactone, polycaprolactone, polybutylene adipate and polyethylene adipate. In this invention, from the standpoint of the elastic properties, suitable use can be made of poly(tetramethylene oxide) glycol, ethylene oxide adducts of poly(propylene oxide) glycol, copolymer glycols of ethylene oxide and tetrahydrofuran, poly(ε-caprolactone), polybutylene adipate and polyethylene adipate. Of these, the use of, in particular, poly(tetramethylene oxide) glycol, ethylene oxide adducts of poly(propylene oxide) glycol and copolymer glycols of ethylene oxide and tetrahydrofuran is recommended. The number-average molecular weight of these segments in the copolymerized state is preferably from about 300 to about 6,000.

Component (b-1) can be produced by a known method. Specifically, use can be made of, for example, the method of carrying out a transesterification reaction on a lower alcohol diester of a dicarboxylic acid, an excess amount of a low-molecular-weight glycol and a low-melting polymer segment component in the presence of a catalyst and polycondensing the resulting reaction product, or the method of carrying out an esterification reaction on a dicarboxylic acid, an excess amount of glycol and a low-melting polymer segment component in the presence of a catalyst and polycondensing the resulting reaction product.

The proportion of component (b-1) accounted for by component (b-1-2) is from 30 to 60 wt %. The preferred lower limit in this case can be set to 35 wt % or more, and the preferred upper limit can be set to 55 wt % or less. When the proportion of component (b-1-2) is too low, the impact resistance (especially at low temperatures) and compatibility may be inadequate. On the other hand, when the proportion of component (b-1-2) is too high, the rigidity of the resin composition (and the molded body) may be inadequate.

The rigid resin serving as component (b-2) is not particularly limited. For example, one or more selected from the group consisting of polycarbonates, acrylic resins, styrene resins such as ABS resins and polystyrenes, polyester resins, polyamide resins, polyvinyl chlorides and modified polyphenylene ethers may be used. In this invention, from the standpoint of compatibility, a polyester resin may be suitably used. More preferably, the use of polybutylene terephthalate and/or polybutylene naphthalate is recommended.

Component (b-1) and component (b-2) are blended in a ratio, expressed as (b-1):(b-2), which is not particularly limited, although this ratio by weight is preferably set to from 50:50 to 90:10, and more preferably from 55:45 to 80:20. When the proportion of component (b-1) is too low, the low-temperature impact resistance may be inadequate. On the other hand, when the proportion of (b-1) is too high, the rigidity of the composition (and the molded body), as well as the molding processability, may be inadequate.

A commercial product may be used as the polyester elastomer (B). Specific examples include those available as Hytrel® from DuPont-Toray Co. Ltd.

Component (B) has a material hardness on the Shore D hardness scale which, from the standpoint of the spin performance and rebound of golf balls obtained by blending component (B) with component (A), is preferably 55 or less, more preferably 50 or less, and even more preferably 45 or less. The lower limit is a Shore D hardness of preferably at least 30, and more preferably at least 35.

Component (B) has a rebound resilience, as measured according to JIS-K 6255, of preferably at least 48%, more preferably at least 55%, and even more preferably at least 60%. When this rebound resilience is low, the rebound resilience of the overall inner core layer resin becomes low, which may lead to a decrease in the ball rebound.

It is desirable for component (B) to be blended in a proportion which is not more than 80 wt % of the inner cover layer-forming resin composition. At above this value, the durability may decrease.

The blending ratio (A)/(B) of component (A) and component (B) is preferably from 20/80 to 80/20 by weight. When the content of component (B) is higher than this range, the durability and moldability may worsen. On the other hand, when the component (B) content is lower than this range, a low hardness and the desired rebound resilience may not be obtained and so the required distance may not be achieved.

The resin composition containing (A) and (B) may include other resin materials in addition to the above-described resin components. The purposes for doing so are, for example, to further improve the flowability of the golf ball resin composition and to increase such ball properties as the rebound and the scuff resistance.

Examples of other resin materials that may be used include polyester elastomers, polyamide elastomers, ionomer resins, ethylene-ethylene/butylene-ethylene block copolymers and modified forms thereof, polyacetals, polyethylenes, nylon resins, methacrylic resins, polyvinyl chlorides, polycarbonates, polyphenylene ethers, polyarylates, polysulfones, polyethersulfones, polyetherimides and polyamideimides. These may be used singly or two or more may be used together.

In addition, an active isocyanate compound may be included in the above resin composition. This active isocyanate compound reacts with the polyurethane or polyurea serving as the base resin, enabling the scuff resistance of the overall resin composition to be further increased. Moreover, the isocyanate has a plasticizing effect which increases the flowability of the resin composition, enabling the moldability to be improved.

Any isocyanate compound employed in conventional polyurethanes may be used without particular limitation as the above isocyanate compound. For example, aromatic isocyanate compounds that may be used include 2,4-toluene diisocyanate, 2,6-toluene diisocyanate and mixtures of both, 4,4-diphenylmethane diisocyanate, m-phenylene diisocyanate and 4,4′-biphenyl diisocyanate. Use can also be made of the hydrogenated forms of these aromatic isocyanate compounds, such as dicyclohexylmethane diisocyanate. Other isocyanate compounds that may be used include aliphatic diisocyanates such as tetramethylene diisocyanate, hexamethylene diisocyanate (HDI) and octamethylene diisocyanate; and alicyclic diisocyanates such as xylene diisocyanate. Further examples of isocyanate compounds that may be used include blocked isocyanate compounds obtained by reacting the isocyanate groups on a compound having two or more isocyanate groups on the ends with a compound having active hydrogens, and uretdiones obtained by the dimerization of isocyanate.

The amount of the above isocyanate compounds included per 100 parts by weight of the polyurethane or polyurea resin serving as component (A) is preferably at least 0.1 part by weight, and more preferably at least 0.5 part by weight. The upper limit is preferably not more than 30 parts by weight, and more preferably not more than 20 parts by weight. When too little is included, a sufficient crosslinking reaction may not be obtained and an increase in the properties may not be observable. On the other hand, when too much is included, discoloration over time due to heat and ultraviolet light may increase, or problems such as a loss of thermoplasticity or a decline in resilience may arise.

In addition, optional additives may be suitably included in the above resin composition according to the intended use thereof. For example, when the golf ball resin composition of the invention is to be used as a cover material, various additives, such as inorganic fillers, organic staple fibers, reinforcing agents, crosslinking agents, pigments, dispersants, antioxidants, ultraviolet absorbers and light stabilizers, may be added to the above ingredients. When such additives are included, the amount thereof per 100 parts by weight of the base resin is preferably at least 0.1 part by weight, and more preferably at least 0.5 part by weight, but preferably not more than 10 parts by weight, and more preferably not more than 4 parts by weight.

In order to suppress as much as possible a decrease in ball rebound and reduction in the distance traveled by the ball on shots with a driver, the rebound resilience of the resin composition, as measured in accordance with JIS-K 6255, must be at least 50%, and is preferably 52% or more, more preferably 55% or more, and most preferably 60% or more.

The resin composition has a material hardness on the Shore D hardness scale which, from the standpoint of the spin properties and durability of the golf ball, must be 52 or less, and is preferably 50 or less, more preferably 48 or less, and even more preferably 46 or less. From the standpoint of moldability, the lower limit in the Shore D hardness is preferably at least 30, and more preferably at least 35.

The resin composition may be prepared by mixing together the ingredients using any of various types of mixers, such as a kneading-type single-screw or twin-screw extruder, a Banbury mixer, a kneader or a Labo Plastomill. Alternatively, the ingredients may be mixed together by dry blending when the resin composition is injection-molded. In addition, in cases where an active isocyanate compound is used, it may be incorporated at the time of resin mixture using various types of mixers, or a resin masterbatch already containing the active isocyanate compound and other ingredients may be separately prepared and the various components mixed together by dry blending when the resin composition is injection-molded.

The method of molding the inner cover layer from the above resin composition may involve, for example, feeding the resin composition into an injection molding machine and molding the inner cover layer by injecting the molten resin composition over the ball core. In this case, the molding temperature differs according to the type of polyurethane or polyurea (A) serving as the chief ingredient, but is typically in the range of 150 to 270° C.

The inner cover layer has a thickness of preferably at least 0.4 mm, more preferably at least 0.5 mm, and even more preferably at least 0.6 mm. The upper limit is preferably not more than 3.0 mm, and more preferably not more than 2.0 mm.

The outer cover layer is formed of a resin composition which includes a polyurethane or polyurea of the same type as component (A) or of a different type.

The outer cover layer-forming resin composition has a material hardness on the Shore D hardness scale which, from the standpoint of the spin properties and scuff resistance of the golf ball, is preferably 65 or less, more preferably 60 or less, and even more preferably 55 or less. From the standpoint of moldability, the lower limit in the Shore D hardness is preferably at least 25, and more preferably at least 30.

The method of molding the outer cover layer may involve, for example, feeding the above resin composition into an injection molding machine and molding the outer cover layer by injecting the molten outer cover layer-forming resin composition over the inner cover layer (intermediate layer)-encased sphere. In this case, the molding temperature differs according to the type of polyurethane or polyurea serving as the chief ingredient, but is typically in the range of 150 to 270° C.

The outer cover layer has a thickness of preferably at least 0.4 mm, more preferably at least 0.5 mm, and even more preferably at least 0.6 mm. The upper limit is preferably not more than 3.0 mm, and more preferably not more than 2.0 mm.

Numerous dimples are provided on the surface of the outermost layer of the inventive golf ball for reasons having to do with the aerodynamic performance. The number of dimples formed on the surface of the outermost layer is not particularly limited. However, to enhance the aerodynamic performance and increase the distance traveled by the ball, this number is preferably at least 250, more preferably at least 270, even more preferably at least 290, and most preferably at least 300. The upper limit is preferably not more than 400, more preferably not more than 380, and even more preferably not more than 360.

In this invention, a coating layer is formed on the cover surface. A two-part curable urethane coating may be suitably used as the coating that forms this coating layer. Specifically, in this case, the two-part curable urethane coating is one that includes a base resin composed primarily of a polyol resin and a curing agent composed primarily of a polyisocyanate.

A known method may be used without particular limitation as the method for applying this coating onto the cover surface and forming a coating layer. Use can be made of a desired method such as air gun painting or electrostatic painting.

The thickness of the coating layer, although not particularly limited, is typically from 8 to 22 μm, and preferably from 10 to 20 μm.

The golf ball of the invention can be made to conform to the Rules of Golf for play. The inventive ball may be formed to a diameter which is such that the ball does not pass through a ring having an inner diameter of 42.672 mm and is not more than 42.80 mm, and to a weight which is preferably between 45.0 and 45.93 g.

### EXAMPLES

The following Examples and Comparative Examples are provided to illustrate the invention, and are not intended to limit the scope thereof.

### Examples 1 to 7, Comparative Examples 1 to 4

A core-forming rubber composition formulated as shown in Table 1 common to all of the Examples was prepared and then molded and vulcanized to produce a 38.6 mm diameter core. It is noted that in Example 6 and Comparative Examples 2, 4, the core-forming rubber composition formulated as shown in Table 1 is prepared and then molded and vulcanized to produce a 38.6 mm diameter core.

TABLE 1

| Rubber composition | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic peroxide (1) | 0.6 |
| Organic peroxide (2) | 1.2 |
| Zinc salt of pentachlorothiophenol | 0.3 |
| Zinc stearate | 1.0 |

Details on the above core material are given below.
cis-1,4-Polybutadiene: Available under the trade name “BR 01” from JSR Corporation
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Nocrac NS6” from Ouchi Shinko Chemical Industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

Next, the inner cover layer material shown in Table 2 below was injection-molded over a 38.6 mm diameter core, thereby producing an inner cover layer (intermediate layer)-encased sphere having an inner cover layer with a thickness of 1.25 mm. The outer cover layer material shown in Table 2 below was then injection-molded over the intermediate layer-encased sphere, producing a 42.7 mm diameter three-piece golf ball having an outer cover layer with a thickness of 0.8 mm. At this time, although not shown in the diagrams, dimples common to all of the Examples and Comparative Examples were formed on the surface of the cover. With regard to the resin composition for the inner cover layer, the ingredients were mixed in the amounts shown in Table 2 by dry blending, and the resulting composition was injection-molded at a molding temperature of between 200° C. and 250° C.

It is noted that in Example 6 and Comparative Examples 2, 4, the inner cover layer material and the outer cover layer material shown in Table 2 are injection-molded, thereby to produce a three-piece golf ball having the dimples on the surface of the cover, in accordance with the above description.

Details on the ingredients included in the compositions in Tables 2 are given below.
TPU 1: An ether-type thermoplastic polyurethane available from DIC Covestro Polymer, Ltd. under the trade name “Pandex” (Shore D hardness, 65; rebound resilience, 34%)
TPU 2: An ether-type thermoplastic polyurethane available from DIC Covestro Polymer, Ltd. under the trade name “Pandex” (Shore D hardness, 55; rebound resilience, 47%)
TPU 3: An aromatic ether-type thermoplastic polyurethane available from DIC Covestro Polymer, Ltd. under the trade name “Pandex” (Shore D hardness, 43; rebound resilience, 61%)
TPEE: A thermoplastic polyester elastomer available from DuPont-Toray Co., Ltd. under the trade name “Hytrel 4001” (Shore D hardness, 37; rebound resilience, 77%)

The flight performance on shots with a driver (W #1), spin performance on approach shots, durability and feel at impact for each of the golf balls were evaluated by the following methods. It is noted that in Example 6 and Comparative Examples 2, 4, the flight performance on shots with a driver (W #1), spin performance on approach shots, durability and feel at impact for each of the golf balls are evaluated by the following methods. The results are shown in Table 2.

Initial Velocity on Shots with Driver (W #1)

A driver (W #1) was mounted on a golf swing robot and the initial velocity of the ball immediately after being struck at a head speed (HS) of 45 m/s was measured with an apparatus for measuring the initial conditions.

### Spin Performance on Approach Shots

A sand wedge (SW) was mounted on a golf swing robot and the initial velocity and backspin rate of the ball immediately after being struck at a head speed (HS) of 20 m/s was measured with an apparatus for measuring the initial conditions.

### Durability

In each Example, a driver (W #1) was mounted on a golf swing robot, ten sample balls (N=10) were repeatedly struck at a head speed of 45 m/s and the average number of shots after which the ball began to crack was determined. Durability indexes were determined for each Example and Comparative Example based on a durability index of 100 for the number of shots on cracking in Example 1.

Rating Criteria:
Good: Durability index was 100 or more
Fair: Durability index at least 80 but less than 100
NG: Durability index was less than 80

### Feel at Impact

Sensory evaluations of the feel of the ball when struck with a driver (W #1) were carried out by ten skilled amateur golfers having head speeds of 45 to 50 m/s, and the feel was rated according to the following criteria.

Rating Criteria:
Good: Six or more of the ten golfers regarded the feel to be good
Fair: Four or five of the ten golfers regarded the feel to be good
NG: Three or fewer of the ten golfers regarded the feel to be good

TABLE 2

| | | | | | | Comparative | | | | | | Comparative | |
|---|---|---|---|---|---|---|---|---|---|---|---|---|---|
| | | | Example | | | Example | | Example | | | | Example | |
| | | | 1 | 2 | 3 | 1 | 2 | 4 | 5 | 6 | 7 | 3 | 4 |
| Inner cover | Composition (pbw) | TBU1 | 40 | 30 | 20 | 100 | 50 | | | | | | |
| layer | | TBU2 | | | | | | 80 | 60 | 50 | 40 | 100 | 95 |
| | | TPEE | 60 | 70 | 80 | | 50 | 20 | 40 | 50 | 60 | | 5 |
| | Properties | Shore D | 50 | 48 | 46 | 65 | 53 | 49 | 46 | 45 | 44 | 55 | 52 |
| | | hardness | | | | | | | | | | | |
| | | Rebound | 54 | 61 | 66 | 34 | 53 | 54 | 59 | 62 | 65 | 47 | 49 |
| | | resilience (%) | | | | | | | | | | | |
| Outer cover layer | Composition (pbw) | TPU3 | 100 | 100 | 100 | 100 | 100 | 100 | 100 | 100 | 100 | 100 | 100 |

| | | | | | | | | | | | | |
|---|---|---|---|---|---|---|---|---|---|---|---|---|
| Ball evaluation | Initial velocity on shots | 66.0 | 66.1 | 66.2 | 65.1 | 65.9 | 65.7 | 65.8 | 65.8 | 65.9 | 64.9 | 65.1 |
| | with driver (m/s) | | | | | | | | | | | |
| | Spin rate on shots | 6,766 | 6,961 | 7,156 | 6,321 | 6,633 | 6,750 | 6,868 | 6,899 | 6,928 | 6,468 | 6,670 |
| | with sand wedge (rpm) | | | | | | | | | | | |
| | Durability | good | good | good | NG | fair | good | good | good | good | fair | fair |
| | Feel | good | good | good | NG | fair | good | good | good | good | NG | fair |

As demonstrated by the results in Table 2, the golf balls of Comparative Examples 1 to 4 are inferior in the following respects to the golf balls according to the present invention that are obtained in the Examples.

In Comparative Example 1, the material hardness of the inner cover layer was high, and so the durability and feel at impact were poor and the spin rate was low. In addition, because a thermoplastic polyester elastomer was not included, the rebound resilience was low and the initial velocity of the ball on shots with a driver (W #1) was also low.

In Comparative Example 2, the material hardness of the inner cover layer is high and so the durability and feel at impact are poor and the spin rate is somewhat low.

In Comparative Example 3, the material hardness of the inner cover layer was high, and so the durability and feel at impact were poor and the spin rate was somewhat low. In addition, because a thermoplastic polyester elastomer was not included, the rebound resilience was low and the initial velocity of the ball on shots with a driver (W #1) was also low.

In Comparative Example 4, a thermoplastic polyester elastomer is included as the inner cover layer material, but the rebound resilience is low and the initial velocity of the ball on shots with a driver (W #1) is also low.

Japanese Patent Application No. 2019-212795 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a rubber core of at least one layer and an inner cover layer and outer cover layer which encase the core, wherein the inner cover layer is formed of a resin composition comprised of:
(A) a polyurethane or polyurea, and
(B) a thermoplastic polyester elastomer,
which resin composition has a Shore D hardness of 52 or less and a rebound resilience of at least 50%; and the outer cover layer is formed of a resin composition comprised of a polyurethane or polyurea of the same type as component (A) or of a different type.

2. The golf ball of claim 1, wherein the resin composition of the inner cover layer has a Shore D hardness of 50 or less and a rebound resilience of at least 52%.

3. The golf ball of claim 1, wherein the proportion of component (B) in the inner cover layer-forming resin composition is 80 wt % or less.

4. The golf ball of claim 1, wherein the component (A) resin material in the inner cover layer-forming resin composition has a Shore D hardness of at least 55 and a rebound resilience of 48% or less.

5. The golf ball of claim 1, wherein the component (B) resin material in the inner cover layer-forming resin composition has a Shore D hardness of 55 or less and a rebound resilience of at least 48%.

6. The golf ball of claim 1, wherein the inner cover layer-forming resin composition has a blending ratio between components (A) and (B) which, expressed as the weight ratio (A)/(B), is from 20/80 to 80/20.
